(19) United States
(12) Patent Application Publication
(10) Pub. No.: US 2026/0216772 A1
(43) Pub. Date: Jul. 30, 2026

(54) EFFICIENT AND FAST DESTRUCTION OF PER- AND POLYFLUOROALKYL SUBSTANCES (PFAS) BY HIGH-FREQUENCY HEATING

(71) Applicant: THE CURATORS OF THE UNIVERSITY OF MISSOURI, Columbia, MO (US)

(72) Inventor: Feng Xiao, Columbia, MO (US)

(21) Appl. No.: 19/001,759

(22) Filed: Dec. 26, 2024

Related U.S. Application Data
(60) Provisional application No. 63/615,671, filed on Dec. 28, 2023.

(51) Int. Cl. B09C 1/06

(52) U.S. Cl. CPC B09C 1/06

(57) ABSTRACT

High-frequency heating (HFH) for the decontamination of soil containing per- and polyfluoroalkyl substances (PFAS) and aqueous film-forming foams (AFFFs) achieves ultra-fast degradation of short-chain PFAS, long-chain homologs, precursors, legacy PFAS, emerging PFAS in a matter of minutes. The concentrations of PFAS and the soil type have a negligible impact on degradation efficiency. Near-complete degradation occurs after one minute for perfluoroalkyl carboxylic acids and perfluoroalkyl ether carboxylic acids and two min for perfluoroalkanesulfonic acids. Polyfluoroalkyl precursors in AFFFs were found to degrade completely within one minute of HFH. No residual cationic, zwitterionic, anionic, or non-ionic intermediate products were detected following the treatment. Most of gaseous organofluorine products of PFAS at low-and-moderate temperatures disappeared when temperatures reached 890° C. Minimal loss of PFAS in water during the boiling process indicates a low risk of PFAS entering the atmosphere with the water vapor. HFH has potential as a remediation tool for PFAS-contaminated soils.

### CROSS REFERENCE TO RELATED APPLICATIONS

This application claims priority under 35 U.S.C. § 119 to provisional patent application U.S. Ser. No. 63/615,671, filed Dec. 28, 2023. The provisional patent application is hereby incorporated by reference in its entirety herein, including without limitation: the specification, claims, and abstract, as well as any figures, tables, appendices, or drawings thereof.

### STATEMENT REGARDING FEDERALLY SPONSORED RESEARCH OR DEVELOPMENT

This invention was made with government support under Grant Number W912HQ23P0073 awarded by the Department of Defense. The government has certain rights in the invention.

### TECHNICAL FIELD

The present invention relates generally to efficient and fast destruction of per- and polyfluoroalkyl substances (PFAS), including but not limited to remediation of soil contaminated by PFAS, by high-frequency heating.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

PFAS are a broad group of synthetic chemicals know5n for their unique properties, including resistance to both water and oil and strong carbon-fluorine bonds. Since their introduction in the 1940s, PFAS have been used extensively in various applications: non-stick cookware, stain-resistant fabrics, firefighting foams, and food packaging. Despite their widespread use and valuable properties, PFAS have emerged as a significant environmental concern due to their persistent, bioaccumulative, and potentially toxic nature.

There are two primary categories within PFAS: perfluoroalkyl substances, with perfluorooctanoic acid (PFOA) and perfluorooctane sulfonate (PFOS) being the most studied, and polyfluoroalkyl counterparts. PFOA and PFOS have been found to cause adverse effects in laboratory animals, including developmental, reproductive, and liver toxicity. Epidemiological studies in humans have also suggested potential links between PFOA and PFOS exposure and various health effects, such as kidney and testicular cancer, thyroid disruption, and immunotoxicity. In addition to perfluoroalkyl substances, numerous polyfluorinated species, or so-called precursors, have been detected in aqueous film-forming foams (AFFFs).

On Apr. 13, 2023, the US EPA started the process to regulate PFAS as hazardous substances under the Superfund Act, including seven PFAS besides PFOA and PFOS, precursors to PFOA, PFOS, and seven other PFAS; and categories of PFAS. This regulatory move underscores the growing emphasis on addressing PFAS-contaminated sites, particularly soil and groundwater.

PFAS contamination in the soil can occur through several pathways, including direct release from industrial sites, landfills, biosolids, and firefighting training areas where PFAS-containing AFFFs are used. Due to the use of AFFFs for fire training alone, more than 400 locations in the United States have been identified where known or suspected releases of PFAS to the soil have occurred. Other sources include atmospheric deposition, wastewater irrigation, and the agricultural use of PFAS-containing biosolids. Once in the soil, PFAS can persist for long periods due to their high stability and resistance to degradation. This persistence poses a risk to both human health and the environment, as PFAS can enter the food chain through the uptake by plants or consumption of contaminated water. Therefore, managing PFAS contamination in soil is crucial to prevent further exposure and ensure the safety of groundwater and food supply.

PFAS, distinguished by their carbon chains where some or all hydrogen atoms are replaced by fluorine, possess strong C—F bonds, granting them remarkable chemical stability and resistance to degradation. While perfluoroalkyl substances (e.g., PFOA and PFOS) contain fully fluorinated carbon chains, polyfluoroalkyl substances have carbon chains that are only partially fluorinated. This difference in chemistry ultimately affects their transport, persistence, and health effects. Under conditions like heating, oxidation, and biological processes, polyfluoroalkyl substances can transform into their fully fluorinated variants, possibly elevating their toxicity.

Various technologies have been developed in the past 30 years to remediate organic-contaminated soils; however, not all these techniques are appropriate for addressing PFAS contamination in solid samples (e.g., soil and spent adsorbent materials). One method, for example, is excavation and disposal at secure landfills or other containment facilities. This method involves physically removing and transporting the contaminated soil to a disposal facility, and then replacing it with clean soil. While it effectively reduces onsite PFAS concentrations, it has limitations like high costs, potential secondary contamination during transit, and the problem of merely relocating the contamination.

An alternative is soil washing, where the soil undergoes treatment using water or solvents to separate organic compounds. The soil interacts with the washing solution, mobilizing PFAS into the liquid phase. After separating the PFAS-containing liquid from the soil, the latter is returned to its origin, while the former undergoes further processing to remove the PFAS. Though effective in certain conditions, soil washing can be expensive and energy-demanding. It requires significant quantities of water or solvents, and subsequent treatment of the contaminated solution is necessary. Its efficacy can also be influenced by factors such as soil type, organic content, and the distribution of contaminants. Additionally, soil washing might not be effective in completely removing PFAS from soil, as some residual contamination may remain.

In situ immobilization is a widely researched soil remediation technique. It employs adsorbent materials, notably activated carbon, biochar, and clay minerals, to capture and secure contaminants within soil. These materials can be added directly to the contaminated soil or used in ex-situ treatment systems, such as permeable reactive barriers or filtration units. While adsorption can effectively reduce the bioavailability of PFAS in the soil environment, it is generally considered a containment strategy rather than a degradation method. Moderately hydrophobic PFAS can potentially be released back into the environment. Additionally, adsorbent materials may require periodic replacement or regeneration after being saturated with PFAS. The effectiveness of the adsorption method can vary depending on factors such as the soil's composition, the type of PFAS, and prevailing environmental conditions, making it challenging to develop a one-size-fits-all solution.

Chemical oxidation techniques, such as supercritical water oxidation, electrochemical oxidation, and photocatalytic decontamination, can break down PFAS in water under specific conditions. However, these methods may be ineffective for degrading PFAS in solid samples (e.g., soil) without water, and they may require carefully controlled conditions to be effective.

Biological treatment methods, such as bioremediation or phytoremediation, involve using microorganisms or plants to degrade or immobilize PFAS in the soil. Some studies have reported the successful degradation of certain PFAS by certain microbial strains or consortia, but the overall effectiveness of biological treatment for PFAS remains limited due to the recalcitrant nature of these compounds. Furthermore, biological treatments of polyfluorinated compounds may lead to the formation of more problematic perfluorinated species. Phytoremediation, the use of plants for remediation, has shown potential in laboratory settings, but its large-scale applicability and efficiency are yet to be conclusively demonstrated.

Previous reports have highlighted the nonlinear sorption of AFFF-related polyfluoroalkyl substances to soil, characterized by concave-down isotherms and irreversible (hysteretic) behaviors. Consequently, PFAS molecules that are irreversibly bound can resist physical (e.g., washing), chemical, or biological treatments, resulting in prolonged periods needed to flush out PFAS plumes from an aquifer than initially anticipated. For instance, numerous studies have shown that soil and groundwater contamination by PFAS persists for several years, and, in some cases, decades, even after contamination activities have ceased.

Thermal treatment methods, encompassing techniques like pyrolysis, thermal air oxidation, thermal desorption, and smoldering, subject contaminated soil to high temperatures to break down PFAS. These methods have shown promise, particularly against recalcitrant short-chain PFAS and perfluoroalkanesulfonic acids (PFSAs), such as PFOS. While thermal techniques can be effective for treating PFAS-contaminated soils, they are generally energy-intensive. Alternative innovative thermal-related strategies, such as ultrasound remediation, gas fractionation, and ball milling, have also been explored. However, these methods necessitate additional research to enhance their effectiveness against specific types of PFAS.

The limitations of the existing methods for PFAS remediation in soil and other solid materials (e.g., spent adsorbent) highlight the need for the development of innovative, energy-efficient, and sustainable solutions to address the challenges posed by PFAS contamination.

### SUMMARY

The present disclosure represents the first instance of using high-frequency heating (HFH) to remediate soils contaminated with PFAS known to the present inventors. HFH employs electromagnetic fields to produce heat in conductive mediums like soil and spent carbon, eliminating the need for direct contact with the heat source. HFH operates on electromagnetic induction; an alternating current in a coil creates an oscillating magnetic field, inducing eddy currents in any conductive material within, generating heat. HFH is a highly energy-efficient process, as heat is generated directly within the target material, minimizing heat loss to the surroundings. HFH sets itself apart from conventional slow heating methods by rapidly increasing the temperature, allowing it to pass quickly through the low to moderate temperature ranges where many fluorinated PFAS species are likely to be formed. HFH offers a more efficient and effective remediation option for PFAS-contaminated soils than other remediation methods, particularly for soils contaminated with PFAS compounds.

The present disclosure describes a series of HFH treatments of soil contaminated by a wide range of PFAS, including short-chain PFAS, perfluoroalkyl carboxylic acids (PFCAs), PFSAs, perfluoroalkyl ether carboxylic acids (PFECAs), and polyfluoroalkyl substances. In addition to legacy PFAS, emerging PFAS such as perfluoro-2,5-dimethyl-3,6-dioxanonanoic acid (HFPO-TA) were included as well. In addition, PFAS-containing AFFFs and surfactant concentrates containing various cationic, zwitterionic, and anionic polyfluorinated compounds were included. The present disclosure is almost undoubtedly the most comprehensive study on PFAS remediation, encompassing a wide array of PFAS classes and their presence in relevant commercial products known to date. Ultimately, the present disclosure provides a foundation for further research in this area and contributes to the development of a more sustainable and eco-friendly approach to PFAS-contaminated soil remediation.

Furthermore, the present disclosure conducts the Monte Carlo estimation of the energy consumption by this innovative method in comparison with mainstream thermal remediation technologies.

Lastly, the potential loss of PFAS to water vapor is a potentially an important factor to consider while studying their thermal degradation in moist soil. Because many PFAS are surfactants, they may attach or adsorb to water vapor or aerosols generated during the thermal treatment. Therefore, we also have assessed the possible loss of PFAS in water in boiling processes, which is pertinent to grasping their possible mobilization during the early stages of heating. Furthermore, this information is vital for effective and safe removal of PFAS from contaminated soil via thermal approaches. It also aids in estimating the potential PFAS inhalation risks that may occur due to their attachment to water vapor or aerosols in other relevant heating processes (e.g., cooking, firefighting, and baking).

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to investigate the feasibility of using HFH for the remediation of solid materials, such as soil and spent adsorbent, contaminated by PFAS.

It is still yet a further object, feature, and/or advantage of the present disclosure to provide a method and system for remediating soil that includes applying an induction heating tool to apply fast heating (HFH) to a combination of soil and PFCA.

It is still yet a further object, feature, and/or advantage of the present disclosure to treat solid waste containing PFAS effective for a broad range of PFAS compounds while achieving rapid degradation. Additionally, the treatment method should be adaptable in rural or remote communities lacking centralized waste treatment facilities.

It is still yet a further object, feature, and/or advantage of the present disclosure to develop a novel magnetic-driven portable high-frequency magnetothermal technique (M-MAT) as a safe and energy-effective alternative to existing remediation approaches such as thermal desorption, smoldering, supercritical water oxidation (SCWO), and hydrothermal alkaline treatment (HALT).

It is still yet a further object, feature, and/or advantage of the present disclosure to evaluate the performance of M-MAT in several conditions.

It is still yet a further object, feature, and/or advantage of the present disclosure to determine the rate-limiting step in PFAS degradation.

It is still yet a further object, feature, and/or advantage of the present disclosure to evaluate the energy requirements of M-MAT compared to current remediation technologies, such as smoldering and thermal desorption.

It is still yet a further object, feature, and/or advantage of the present disclosure to address the underlying mechanisms through which this magnetic-assisted method accelerates the degradation of PFAS, how do these mechanisms differ from those in traditional thermal degradation processes, how can these mechanisms improve the current thermal treatment remediation technologies, how does the efficiency of M-MAT vary across different matrices, such as spent GAC, AIX resins, and contaminated soils, and how efficiently M-MAT decomposes PIDs of PFAS and co-contaminants (e.g., 1,4-dioxane, polycyclic aromatic hydrocarbons, and HS).

According to some aspects of the present disclosure, a method for remediating soil comprises applying an induction heating tool to apply HFH to a combination of soil and PFAS.

According to some additional aspects of the present disclosure, the method further comprises treating soil containing the PFAS and the organic matter.

According to some additional aspects of the present disclosure, the method further comprises achieving rapid degradation with said high-frequency heating without having to transport the soil to a centralized waste treatment facility.

According to some additional aspects of the present disclosure, the method further comprises employing an electromagnetic field to heat the soil without directly contacting a heat source. The heat source can be an alternating current in a coil that creates an oscillating magnetic field, inducing eddy currents in a conductive material therewithin.

According to some additional aspects of the present disclosure, the organic matter comprises spent carbon.

According to some additional aspects of the present disclosure, the method further comprises, in less than one hundred and twenty seconds (120 s), increasing the temperature in the soil to a temperature above where fluorinated PFAS are formed.

According to some additional aspects of the present disclosure, the PFAS comprise PFCAs. The PFCAs can be selected from the group consisting of: perfluorobutyric acid (PFBA), perfluoropentanoic acid (PFPeA), perfluorooctanoic acid (PFOA), perfluorononanoic acid (PFNA), perfluorodecanoic acid (PFDA), perfluoroundanoic acid (PFUnDA), and perfluorooctanoic acid (PFOA). The method can further comprise targeting at least one C—F bond in the PFCAs.

According to some additional aspects of the present disclosure, the PFAS comprise PFSAs. The PFSAs can be selected from the group consisting of: perfluorobutane sulfonic acid (PFBS), perfluorohexane sulfonic acid (PFHxS) and perfluorooctane sulfonic acid (PFOS). The method can further comprise targeting at least one S—F bond in the PFSAs.

According to some additional aspects of the present disclosure, the PFAS comprise PFECAs. The PFECAs can be selected from the group consisting of: perfluoro-2-methyl-3-oxahexanoic acid (HFPO-DA), perfluoro-2,5-dimethyl-3,6-dioxanonanoic acid (HFPO-TA), and perfluoro-2,5,8-trimethyl-3,6,9-trioxadecanoic acid (HFPO-TeA). The method can further comprise targeting at least one O—F bond in the PFECAs.

According to some other aspects of the present disclosure, a portable HFH device for synthetically producing geothermal energy comprises a coil capable of creating an alternating current in an oscillating magnetic field; a conductive material through which eddy currents are induced by the coil to generate heat in soil; and a mount for securing the portable HFH device in a stable position with respect to the ground while the heat is generated.

According to some additional aspects of the present disclosure, the portable HFH device further comprises a reaction chamber through which the soil is moved through as the soil is heated.

According to some additional aspects of the present disclosure, the portable HFH device further comprises an infrared thermometer for monitoring a temperature of the soil.

According to some other aspects of the present disclosure, a magnetic-driven portable high-frequency magnetothermal (M-MAT) method comprises rapidly decomposing per- and polyfluoroalkyl substances (PFAS) in less than one hundred twenty seconds (120 s); specifically targeting mineralizing products of incomplete destruction (PIDs) of PFAS; and applying a magnetic-driven portable high-frequency magnetothermal (M-MAT) technique to destroy (i) PFAS in biosolids, (ii) spent granular activated carbon (GAC), and/or (iii) spent anion exchange (AIX) resins.

According to some additional aspects of the present disclosure, the method further comprises removing and decomposing hydrocarbon surfactants (HS) that are in aqueous film-forming foams (AFFFs). These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIGS. 1A-1B show HFH (up to 2 min) of a mixture of PFCAs added to natural soil (0.2 g) in a sealed steel reactor. The initial mass of each PFCA was 0.02 μmol. The decomposition efficiency was assigned to 100% if no measurable PFCA was found after the thermal treatment. Note that the actual PFCA heating time is longer than the HFH time (e.g., twenty seconds) as it took approximately sixty-five seconds (65 s) to cool down from ~845° C. to room temperature.

FIG. 2A shows HFH (up to two minutes) PFSAs added to 0.2 g of natural soil in a sealed steel reactor. The initial mass of each PFAS was 0.02 mol. The decomposition efficiency was assigned to 100% if no measurable PFAS was found after the thermal treatment. Note that the actual PFAS heating time is longer than the HFH time (e.g., twenty seconds) as it took approximately sixty-five seconds (65 s) to cool down from ~845° C. to room temperature.

FIG. 2B shows HFH (up to two minutes) PFECAs added to 0.2 g of natural soil in a sealed steel reactor.

FIG. 3A shows degradation of PFAS preadsorbed to natural soil by one-minute (1-min) HFH.

FIG. 3B shows degradation of PFAS preadsorbed to natural soil by two-minute (2-min) HFH.

FIG. 3C shows 2-min HFH treatments of PFAS (0.02 μmol) added to different types of soils (0.2 g).

FIG. 4A shows HFH (1 min) of polyfluoroalkyl substances present in AFFFs (#1 and #2) with the presence of natural soil (0.1 g) in a sealed reactor. The decomposition efficiency was assigned to 100% if no measurable PFAS was found after the thermal treatment.

FIG. 4B shows PFAS present in two AFFFs involved in HFH experiments of this study. The x-axis numbers (e.g., 460.9334) are the m/z values of these per- and polyfluoroalkyl substances shown in FIG. 4B.

FIG. 4C shows surfactant concentrates for FC-100 with the presence of natural soil (0.1 g) in a sealed reactor. The decomposition efficiency was assigned to 100% if no measurable PFAS was found after the thermal treatment.

FIG. 4D shows cationic and zwitterionic polyfluoroalkyl substances present in one surfactant concentrate (FC-100) sample involved in the induction experiments of FIG. 4C. The x-axis numbers (e.g., 567.0876) in FIG. 4C are the m/z values of these cationic and zwitterionic polyfluoroalkyl substances shown in FIG. 4D.

FIG. 4E shows surfactant concentrates for FC-170 C with the presence of natural soil (0.1 g) in a sealed reactor. The decomposition efficiency was assigned to 100% if no measurable PFAS was found after the thermal treatment.

FIG. 4F shows non-ionic polyfluoroalkyl substances present in one surfactant concentrate (FC-170C) sample involved in the induction experiment of FIG. 4E. The x-axis numbers (e.g., 616.0092) of FIG. 4E are the m/z values of these non-ionic polyfluoroalkyl substances shown in FIG. 4F.

FIGS. 5A-5C show formation of fluorinated species from PFAS in three AFFF samples, including AFFF #1 (i.e., AFFF 5-79), when subjected to fast heating rates (6.7° C./sec) from fifty degrees Celsius (50° C.) to varying temperatures.

FIG. 6 shows a mass loss of PFAS from water after boiling the water at 100° C. for twenty-five minutes.

FIGS. 7A-7C show an estimation of heat consumption by means of Monte Carlo simulation for three thermal treatment processes (HFH, thermal desorption, and smoldering) for removing PFAS from soil.

FIG. 8 shows an experimental setup with a dual-laser infrared thermometer monitoring a heating device and sealed reactor. The dual-laser infrared thermometer is connected to a laptop.

FIG. 9 shows a schematic illustration of a magnetic-driven portable high-frequency magnetothermal technique (M-MAT). The M-MAT concept operates fundamentally on the Joule heating effect, wherein the heat is generated within a metallic reactor through electromagnetic induction, eliminating the need for direct contact between the induction heater and the reactor. Additional heat is produced by hysteresis losses for magnetic materials during thermal treatment.

FIGS. 10A-B show M-MAT treatment (up to 120 s) of PFCAs, HFPO-DA, and potassium salt of perfluoroalkyl sulfonates (K-PFSAs) in an air atmosphere in a M-MAT reactor. FIG. 10A shows the initial mass of each PFAS was 0.02 μmol in multi-PFAS systems with or without GAC (0.1 g). FIG. 10B shows M-MAT treatments of PFAS pre-adsorbed on different amounts of GAC (0.01, 0.02, 0.04, 0.06, 0.09, 0.12, 0.15, and 0.2 g). The decomposition efficiency was assigned to 100% if no measurable PFAS was found after the thermal treatment.

FIG. 11 shows M-MAT treatment of a mixture of PFAS pre-adsorbed on a single-use AIX resin in an air atmosphere. The loadings (umol/gAIX) are as follows: PFBA, 6.42-7.65; PFPeA, 1.65-2.05; PFOA, 2.58-3.30, PFNA, 13.2-17.8; PFDA, 8.86-10.9; PFUnDA, 10.3-12.5; K-PFBS, 2.56-3.15; K-PFHxS, 1.42-2.02; and K-PFOS, 2.42-3.15. The decomposition efficiency was assigned to 100% if no measurable PFAS was found after the thermal treatment.

FIG. 12 shows a schematic showing the in-situ M-MAT device for remediation of PFAS-contaminated soil.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

This analysis included six PFCAs (e.g., PFOA), three PFSAs (e.g., PFOS), and three PFECAs that have been produced as alternatives to PFOA and PFOS, see Table 1.

TABLE 1
PFCAs, PFSAs, and PFECAs included the HFH experiment described herein

| PFAS | Acronyms | Purity | CAS # |
|---|---|---|---|
| perfluorobutyric acid (C4) | PFBA | ≥99.5% | 375-22-4 |
| perfluoropentanoic acid (C5) | PFPeA | 97% | 2706-90-3 |
| perfluorooctanoic acid (C8) | PFOA | 95% | 335-67-1 |
| perfluorononanoic acid (C9) | PFNA | 97% | 375-95-1 |
| perfluorodecanoic acid (C10) | PFDA | 98% | 335-76-2 |
| perfluoroundanoic acid (C11) | PFUnDA | 95% | 2058-94-8 |
| perfluorobutanesulfonic acid potassium salt (C4) | PFBS | 98.0% | 29420-49-3 |
| perfluorohexanesulfonic acid potassium salt (C6) | PFHxS | ≥98.0% | 3871-99-6 |
| perfluorooctanesulfonic acid potassium salt (C8) | PFOS | ≥98.0% | 2795-39-3 |
| perfluoro-2-methyl-3-oxahexanoic acid | HFPO-DA | 97% | 13252-13-6 |
| perfluoro-2,5-dimethyl-3,6-dioxanonanoic acid | HFPO-TA | 97% | 13252-14-7 |
| perfluoro-2,5,8-trimethyl-3,6,9-trioxadecanoic acid | HFPO-TeA | 95% | 65294-16-8 |

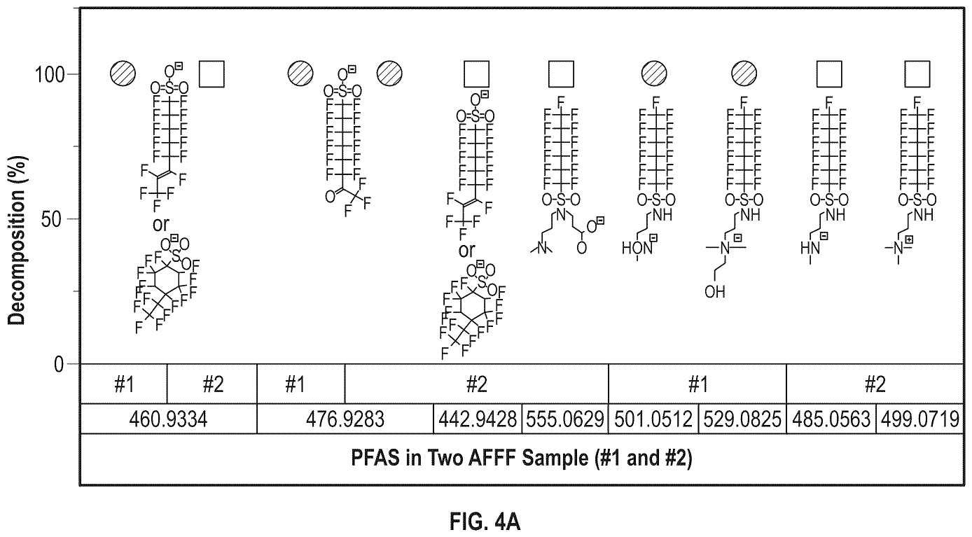

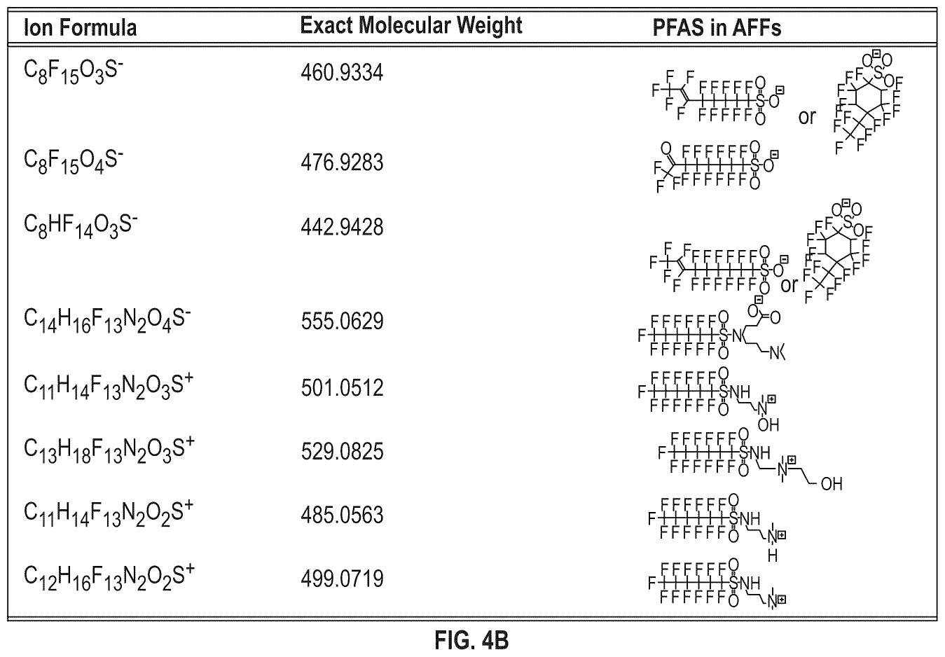

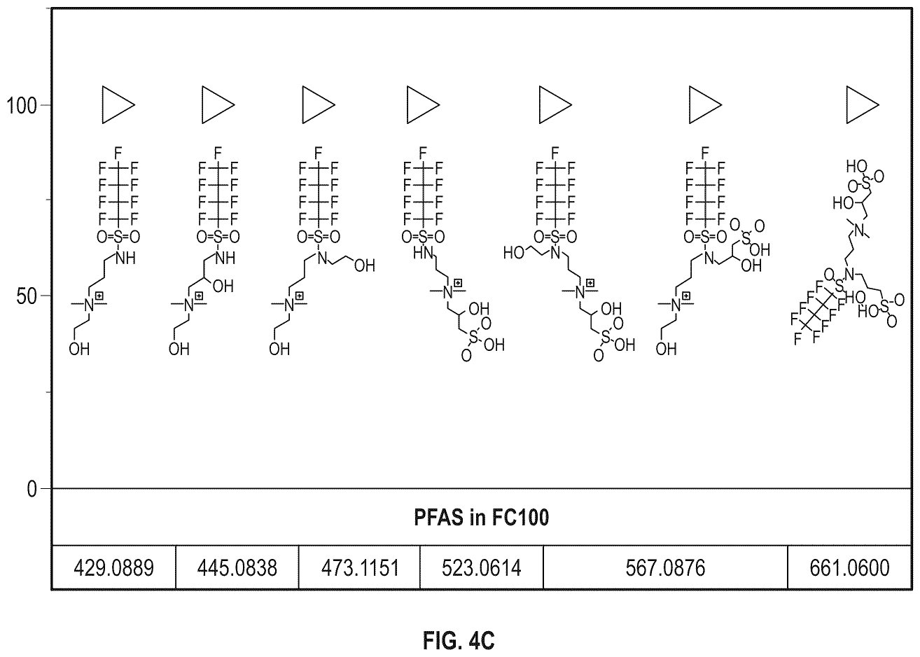

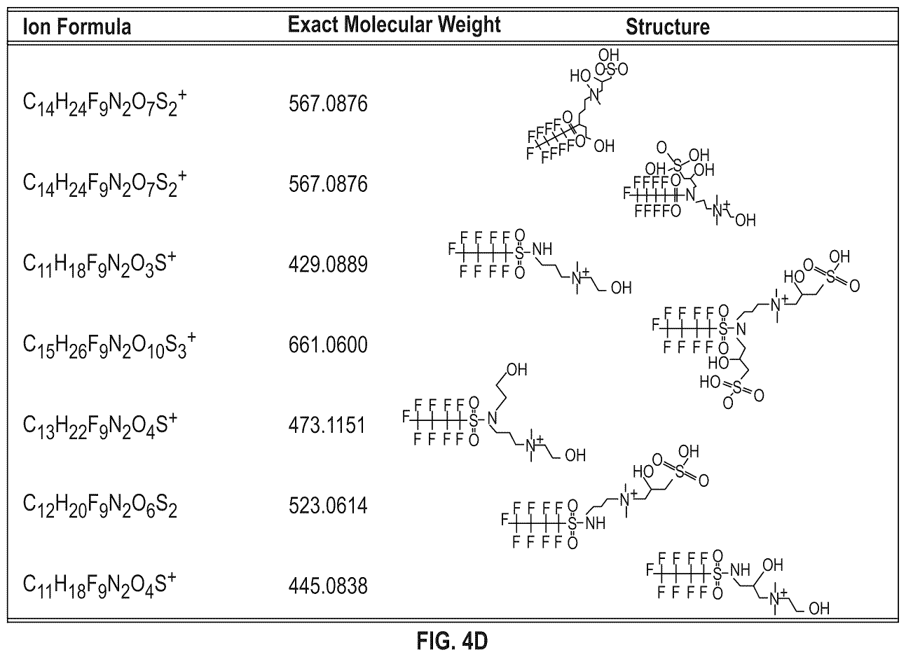

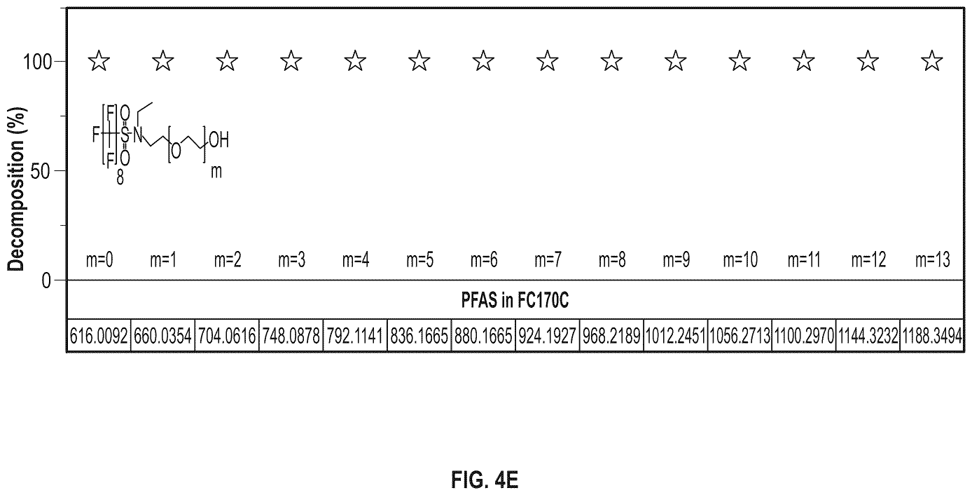

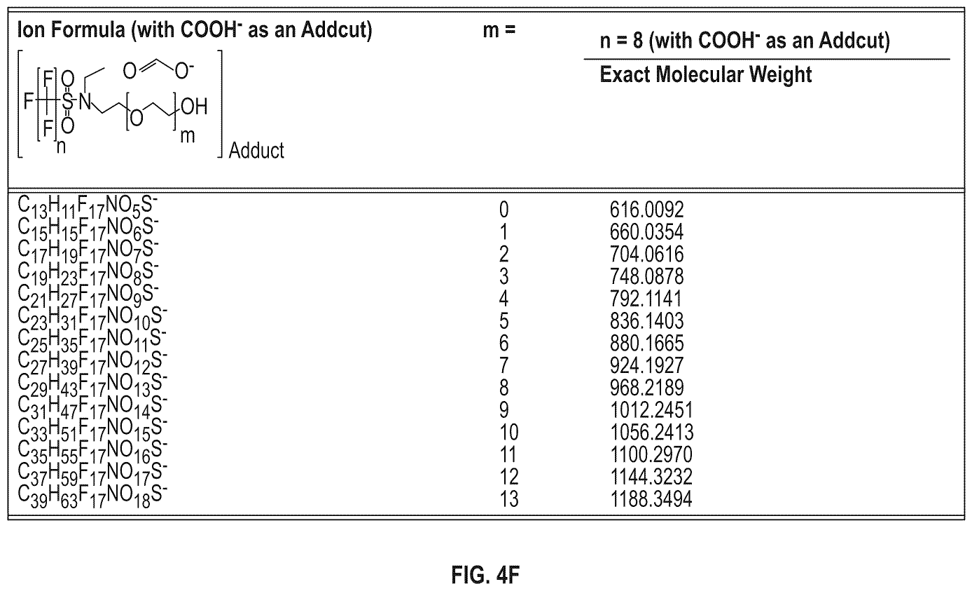

The structures of PFAS are shown in FIGS. 4B, 4D, and 4F, which are described in more detail infra. Chemicals were purchased from Sigma-Aldrich. This study also included two 3 M AFFF samples (3% v/v) (#1 and #2) containing a mixture of anionic perfluorinated compounds and anionic, zwitterionic, and cationic polyfluoroalkyl substances, as shown in FIG. 4B. Lastly, two “Fluorad” brand fluorosurfactant concentrates containing cationic, zwitterionic, and non-ionic polyfluoroalkyl substances, see FIG. 4D and FIG. 4F, were included in the HFH experiment.

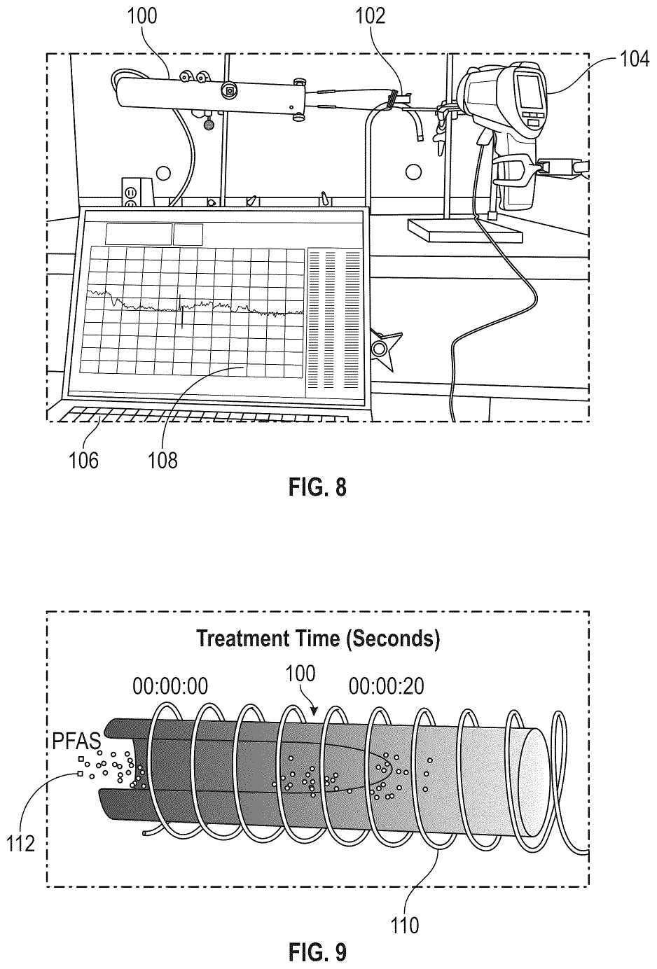

The HFH device was a handheld induction-heating tool 100 (Bolt Buster™) procured from LACE Technologies, Inc. (Addison, IL, USA). The maximum operating time of this HFH device is two minutes (2 min). Stainless steel reactors 102 (7 mL; 45 mm in height and 19 mm in outside diameter) with a stainless-steel screw lid were obtained from the QAQC Lab Inc. (White Stone, VA, USA) for HFH experiments. The reactor temperature during HFH was recorded using a Digi-Sense dual-laser infrared thermometer 104 (Cole Parmer, IL, USA) in a continuous scan mode connected to a computer 106 with an infrared thermometer software package 108, see FIG. 8.

According to some aspects of the present invention, the handheld induction-heating tool 100 can be incorporated into an in-field system for heating the soil. Namely, the handheld induction-heating tool 100 can further comprise: a mount for securing the portable HFH device in a stable position with respect to the ground while the heat is generated. For example, the mount can be stakes or helical screws which can be driven into the soil to keep the handheld induction-heating tool 100 in a fixed position while the soil is heated. In another example, the mount can be a truss that includes wheels. The truss mounts the handheld induction-heating tool 100 in a stable position can thus be easily moved throughout the field to heat different areas of the field. In yet another example, the handheld induction-heating tool 100 could be hung from a computer-controlled, cable-suspended system, similar to the SkyCam™, and thus maneuvered through three dimensions in the field.

Two potential scenarios were examined, namely Scenario #1 and Scenario #2, to demonstrate the impact of four variables. These variables encompass thermal attributes (i.e., HFH duration), characteristics of PFAS, the texture of the soil, and the concentration of PFAS within the soil.

The pre-adsorption of perfluorinated chemicals in soil shown in Table 1 was performed in batch sorption experiments following the previous procedure. The liquid phase was a landfill leachate sample provided by Waste Management Inc. No measurable PFAS were detected in microfiltered landfill leachate samples. The soil was a clay loam with an organic matter content of 9.8% and a cation-exchange capacity of 41.0 cmol/kg. Leachate samples were spiked with PFAS (Table 2) to ~2×10⁻⁶ mol/L in the laboratory to facilitate detection. The apparent sorption equilibrium was reached after two days. After sorption, the supernatant fluid was decanted. The remaining PFAS-laden soil particles were freeze-dried, stored in a desiccator to reach room temperature, and thermally treated in a sealed steel reactor by HFH.

TABLE 2
Comparison of conventional heating and HFH for decomposition of PFAS.

| | Conventional heating (slow | |
|---|---|---|
| | heating) | HFH (fast heating) |
| Temperature (° C.) at | 150-900 (PFOA and HFPO- | 500%-845 |
| which PFAS | DA) | |
| degradation was | 450-900 (PFOS) | |
| observed | | |
| Typical heating rate | 10° C./min | 16° C./sec |
| Residence time | Minutes to hours | Seconds |
| Reactors and heating | Furnace or oven | Metallic reactor |
| method | Heat is transferred through | Heat is generated within the |
| | conduction, convection, and | metallic reactor by |
| | radiation | electromagnetic induction |
| Advantages | A mature heating technology | Rapid heating |
| | Relatively easy to scale up | High heating efficiency |
| | | (80-90%) |
| | | High energy conversion |
| | | efficiency |
| | | Precise temperature control |
| | | and fast heat-up times |
| | | HFH reactors are easy to |
| | | install and maintain |
| Disadvantages | Low heating efficiency (e.g., | Corrosion of the metallic |
| | 20-40% for coil heaters), and thus | reactor |
| | requiring a longer heating time | An emerging PFAS |
| | to achieve PFAS degradation. | treatment technology, which |
| | High energy consumption | lacks generalized |
| | Long startup, processing, and | information |
| | cooling times | |
| | Generation of various | |
| | fluorinated intermediates at low | |
| | to moderate temperatures | |

In the case of the second scenario, experiments were conducted by directly integrating PFAS substances or AFFF with soil particles. This was done to emulate the unrestricted presence of PFAS molecules in the soil and those molecules that have only a weak association with soil particles. In brief, AFFF or surfactant methanol stock solutions were prepared by adding 80 μL AFFF or surfactant concentrate solution into 200 mL of HPLC-grade methanol (Thermo Fisher Scientific, Pittsburgh, USA). An aliquot (1 mL) of the AFFF or surfactant concentrate methanol stock solution was added to the stainless-steel reactor (without a lid) and dried in a forced-air oven at 25° C. Then, a known amount (0.1 g) of dry natural soil was added to the reactor, which was then screwed tight using clamps and heated by the induction heater for 1 or 2 min. In addition to the natural soil (a clay loam), this study also included a reference clay (KGa-1b kaolinite) purchased from the Clay Minerals Society (GA, USA) and the Pahokee peat, a high-organic (56% organic carbon) reference material (IHSS; St. Paul, MN).

The potential loss of PFAS mass during the process of water boiling was also investigated. The setup consisted of a 500-mL round-bottom evaporation flask, on a heater, containing 100 mL of distilled water spiked with a PFAS mixture. To determine the initial PFAS concentration prior to heating, we collected three samples from this solution. This flask was then linked to a 250 mL round-bottom flask via a distillation column condenser, designed to collect the evaporated solution. The column condenser was maintained at a low temperature by circulating cold tap water through it, which facilitated the cooling and condensation of vapors originating from the evaporation flask. The solution was allowed to boil for 25 min, after which we collected three samples each from both the evaporation and receiving flasks, once the solutions had sufficiently cooled.

There was considerable effort in profiling the gaseous emissions from PFAS and their heat-induced degradation by-products. In one study, the gaseous products resulted from the thermal decomposition of AFFF samples, see Table 2. This very same system has been deployed in earlier research efforts, where it was used to examine the gaseous by-products formed during the thermal treatment of long-chain and short-chain PFAS. For this study, unpublished findings from prior work were used to shed light on the gaseous emissions resulting from the rapid heating of AFFF samples. The analyses were conducted by using a Frontier 3030D thermal desorption-pyrolysis system (Frontier Labs Inc., Japan) coupled with a gas-chromatography-mass spectrometry (GC-MS) system (Agilent GC 7890 and 5975 C MS; Santa Clara, CA). A Frontier 30-m Ultra Alloy capillary column was utilized from Frontier Labs Inc. (Japan), which had an inner diameter of 0.25 mm and was equipped with a 5% diphenyldimethyl polysiloxane stationary phase with a 0.25 μm film thickness. The MS analysis was carried out using electron ionization, surveying the mass range of 35-850 m/z. Ultra-pure helium with a purity level of 99.999% served as the carrier gas, employed at a constant flow rate of 1.1 mL/min. In the experiment, an AFFF sample was subjected to heating at 400° C./min (or 6.7.C/sec), starting from 50° C. and escalating to various temperatures. The data processing stage incorporated the evaluation of the MS fragmentation pattern of potential pyrolyzates, leveraging the extensive 2005 National Institute of Standards and Technology library, which houses 190,825 spectra. Any compounds were considered provisionally identified if they demonstrated a library match quality exceeding 70%.

Consider a reactor with a total surface area (A) of 600 cm² containing 100 g GAC (density: 700 kg/m³) through which the heat is being conducted. The energy consumed by heating this reactor was estimated using Monte Carlo simulations that consider all possible combinations of key independent variables. Three thermal treatment approaches were compared for achieving 99% degradation/removal of PFAS from solid materials, including HFH (T=500-845° C.; t=20-120 s) (this study), thermal desorption (T=200-500° C.; t=5-20 d), and smoldering (T=600-1100° C.; t=1-24 h). The heat transfer rate (Φ) caused by heat convection was calculated using the Newton's law of cooling:

$${Φ}_{convection} = hA Δ T ,$$

where Φ is the heat transfer rate (W); h is the surface heat transfer coefficient (3.42 W/m²·K for air and estimated at 0.25 W/m²·K for soil); ΔT is the temperature difference (K). The transfer rate of heat radiation was estimated by the Stefan Boltzmann equation:

$${Φ}_{radiation} = {ε}_{1} A σ ( {T}_{1}^{4} - {T}_{2}^{4} ) ,$$

where ε₁ is the emissivity (0.9); σ is Stefan Boltzmann constant (5.67×10⁻⁸ W/m²·K⁻⁴); T₁ and T₂ are temperatures (K) of the reactor and the ambient air, respectively.

Combining the previous two equations, the total heat consumption (E, kW·h) can be estimated using Monte Carlo simulations:

$$E = \{ hAF ( Δ T ) + {ε}_{1} A σ [ ( {F ( {T}_{1} )}^{4} - {T}_{2}^{4} ) ] \} \times F ( t ) / 1000 ,$$

where F represents the frequency in Monte Carlo simulations, and t is the treatment time. The peak of this frequency distribution curve shows the most probable value of E within the ranges of T₁ and t.

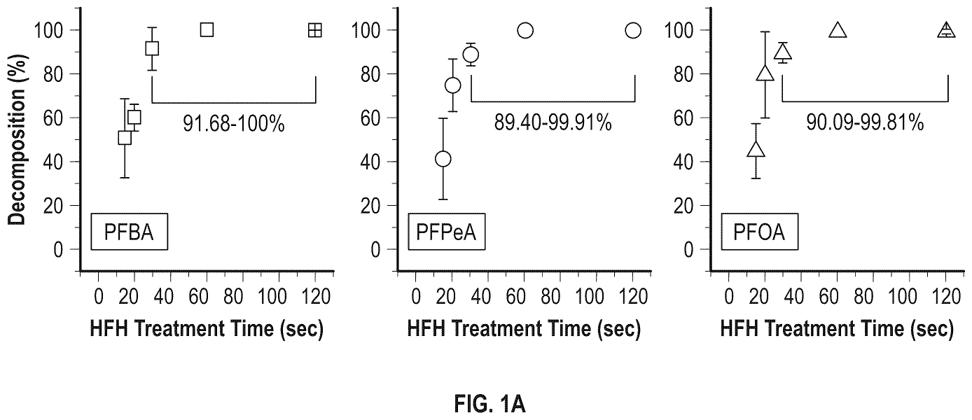

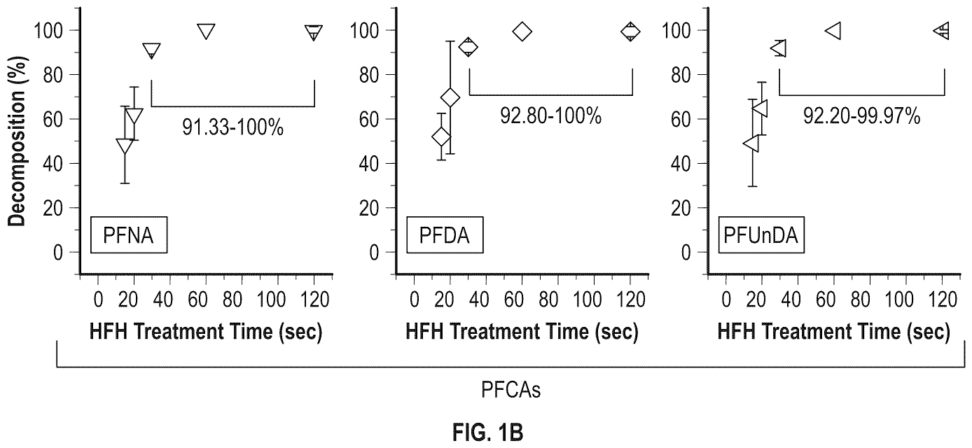

FIGS. 1A-1B illustrates the degradation of soil-borne PFCAs with varying chain lengths subjected to HFH in soil. The degradation curves exhibited an overall inverted L-shape, indicating that degradation efficiency increased with HFH time. For instance, PFOA degradation was 45.16% after fifteen seconds (15 s) of HFH, while this efficiency escalated to 99.91% when the heating time was extended to sixty seconds (60 s). The PFAS chain length did not significantly impact the degradation. This observation is exemplified by the comparable degradation efficiencies of PFBA and PFOA, which is also mirrored in PFAS degradation during heating at a regular rate.

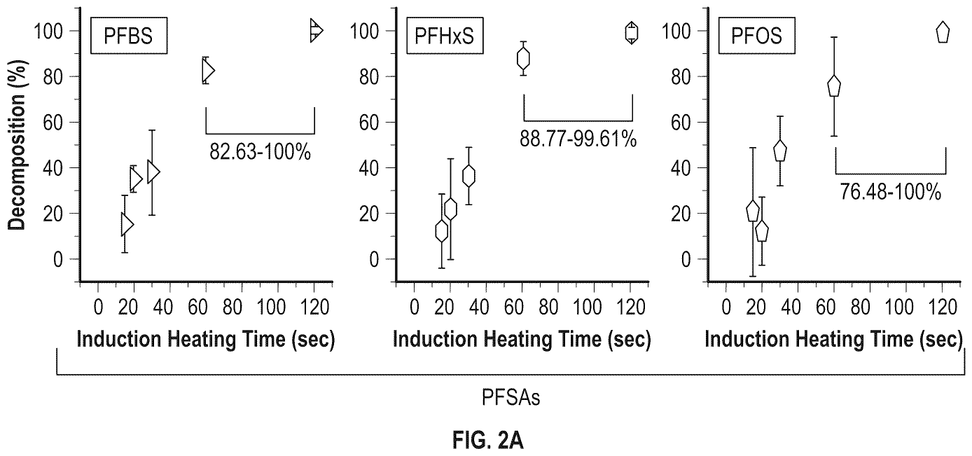

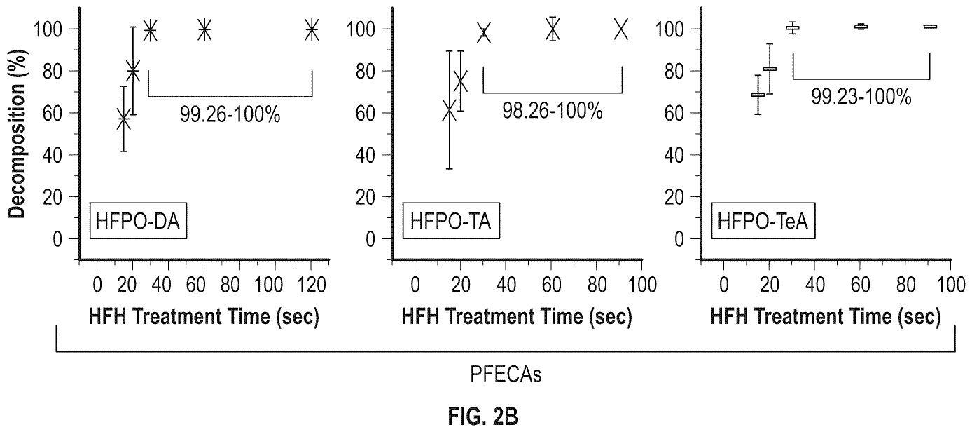

The type of PFAS, including their functional groups, affects the degradation efficiency under HFH. The degradation of PFSAs was markedly lower than that of PFCAs, particularly in instances of ultrashort treatment time, as shown in FIGS. 1A-1B and 2A-2B. For example, after thirty seconds (30 s) of HFH, PFBS degradation reached 37.82% (FIG. 2A, left panel), while PFBA, its corresponding PFCA counterpart, achieved a 91.68% degradation rate (FIG. 1A, left panel). Conversely, PFECA degradation appeared more efficient than PFCA degradation (FIGS. 1A-1B & 2B). After fifteen seconds (15 s) of HFH, 57% of HFPO-DA had already degraded.

Temperature plays a critical role in the degradation of PFAS under thermal conditions. While PFOA degradation can occur at low temperatures (150-200° C.) with the presence of granular activated carbon, a much higher temperature (>700° C.) would be needed to achieve a mineralization rate of <80%. In this study, the steel reactor temperature rapidly increased to approximately 500° C. within thirty seconds (30 s) at a heating rate of 14.5° C./sec, and subsequently rose to approximately 845° C. after one minute (1 min), see Table 3. The infrared thermometer considerably underreported the temperature of steel, a low-emissivity material, see Table 3.

TABLE 3
Temperatures of the steel reactor during
HFH monitored by two approaches.

| Time (sec) | Temp (° C.)¹ | Color | Temp (° C.)² |
|---|---|---|---|
| 30 | 260° | Faint red | 500 |
| 45 | 290 | Dark Cherry | 635 |
| 60 | 406.2 | Salmon | 845 |

¹Measured by a Digi-Sense dual-laser infrared thermometer that underestimated the temperature of steel, a low-emissivity material.
²Estimated by the color change of the steel reactor during induction heating.

The high temperatures induced by the HFH device were the critical factor in achieving the complete degradation of PFAS in such a short period of time, as shown in FIGS. 1A-1B.

Treatment time apparently is an important factor influencing the degradation of PFAS in soil under HFH. Longer treatment times can allow for more complete degradation of PFAS. Based on the aforementioned discussion, it appears that 1 min of HFH is adequate for achieving near-complete degradation (approximately 100%) of PFCAs and HFPODA. For PFSAs, 2 min of HFH treatment is necessary to attain a similar degradation rate. Following two minutes (2-min) of HFH, the degradation of all PFAS in soil neared 100% (FIGS. 1A-1B and FIGS. 2A-2B).

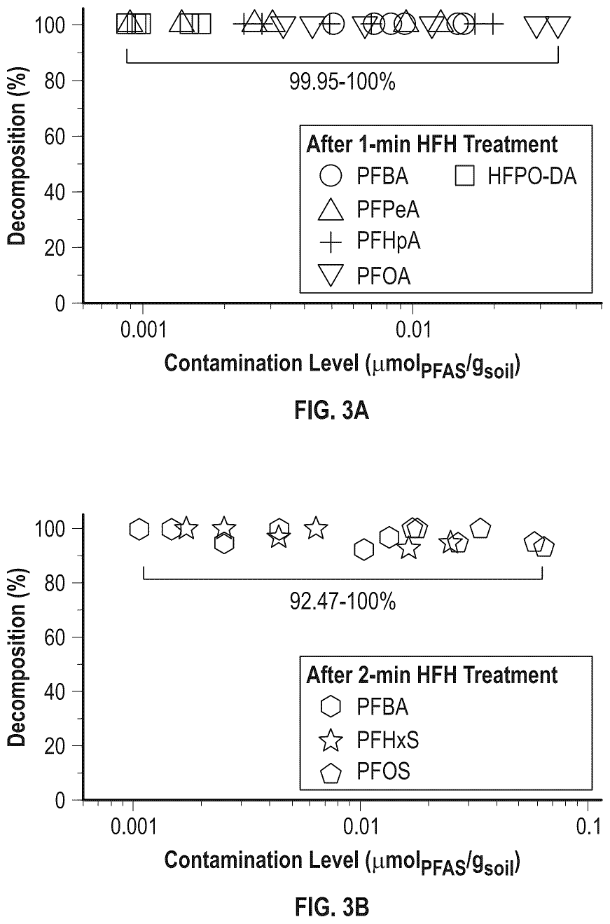

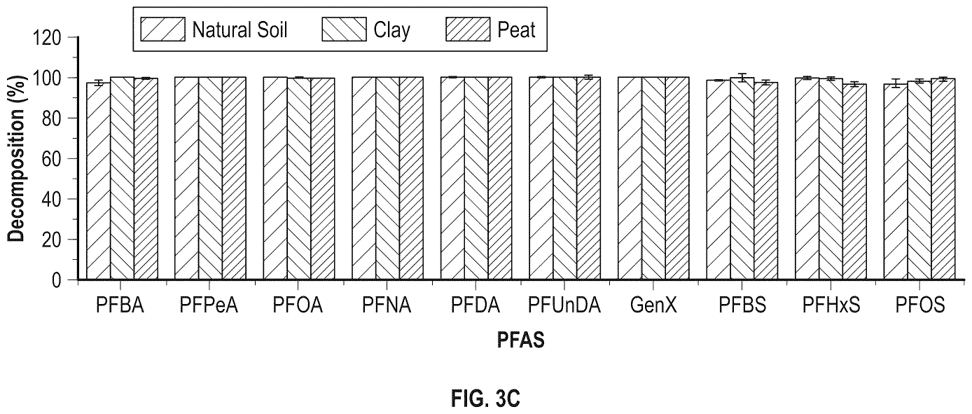

The contamination level of PFAS in the soil is another potentially important factor affecting the efficiency of chemical and biological treatments. FIGS. 3A-3B display the degradation of PFAS adsorbed onto the soil at varying concentrations subjected to HFH. The figures employ a logarithmic scale for the horizontal axis, as the concentrations of PFAS in the soil span two orders of magnitude. As depicted in the figure, PFAS in the soil exhibited high degradation rates at both low and high concentrations following one or two minutes (1 or 2 min) of HFH treatment.

Furthermore, the type of soil in which PFAS contamination occurs can significantly impact the degradation efficiency under HFH. Factors such as organic matter content and mineralogy can influence the heating characteristics, heat distribution, and the interaction between PFAS and soil components. For example, soils with higher clay content may require more energy to heat due to their low thermal conductivity, while soils with high organic matter content can potentially enhance the degradation of organic compounds by facilitating the reactive species. The presence of certain minerals, such as iron or other metal oxides, in soil has also been reported to enhance PFAS degradation, possibly due to their catalytic activity at high temperatures.

It was found that soil type had a negligible effect on the degradation of PFAS compounds during HFH. The degradation rate of PFAS in different soils approached 100%, as shown in FIG. 3C. This is likely because the ultra-fast degradation rate of PFAS under high temperatures (as induced by the HFH device) overwhelmed any potential differences in soil properties. Specifically, the results demonstrated that PFAS compounds were rapidly degraded within a matter of minutes in all three types of soils with different amounts of minerals and organic matter, as shown in FIGS. 3A-3C. Therefore, the soil type does not play a significant role in the efficacy of HFH as a remediation technique for PFAS-contaminated soils.

In addition to perfluoroalkyl substances, numerous structurally similar compounds known as polyfluoroalkyl substances have been identified, which contain a non-fluorinated branched chain. The degradation of AFFF and polyfluoroalkyl substances in surfactant concentrates during HFH were investigated. Polyfluoroalkyl substances are more susceptible to pyrolysis than perfluoroalkyl substances. It was discovered that one minute (1 min) of HFH resulted in complete degradation (100%) of polyfluoroalkyl substances (FIGS. 4A, 4C, and 4E). After one minute (1 min), no residual cationic, zwitterionic, anionic, and non-ionic polyfluoroalkyl substances, see Table 1, FIG. 4B, FIG. 4D, and FIG. 4F, were detected. This finding further underscores the effectiveness of HFH in treating PFAS-contaminated soil. When exposed to low to moderate heat, polyfluoroalkyl substances- or precursors-within these AFFF samples can convert into perfluorinated compounds. The generation of intermediate products from precursors follows a bell-shaped curve; they are produced at low to moderate heat levels and then degrade when subjected to higher temperatures. In this study, there were no detected perfluorinated transformation products after subjecting the polyfluoroalkyl substances in AFFFs to HFH for one minute (1 min). This implies a swift degradation of the precursors and intermediate products when formed at low and moderate temperatures.

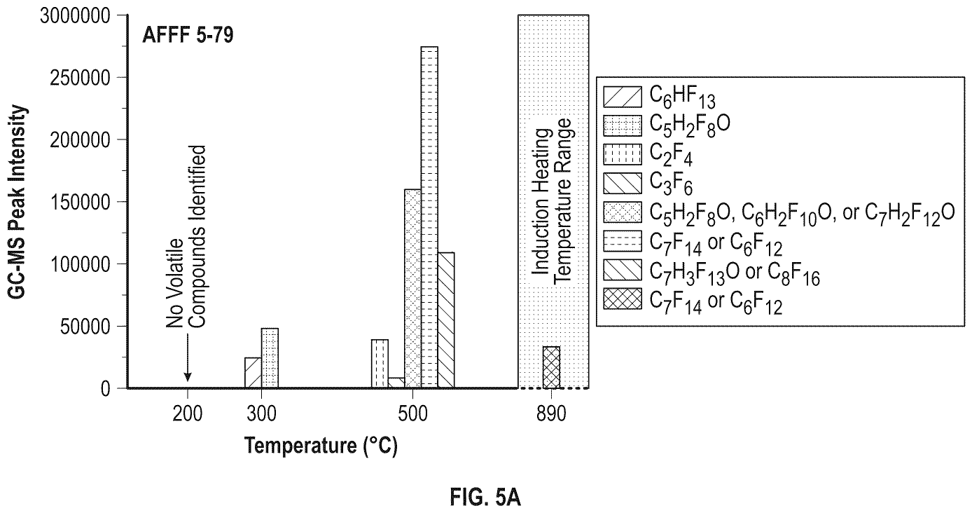

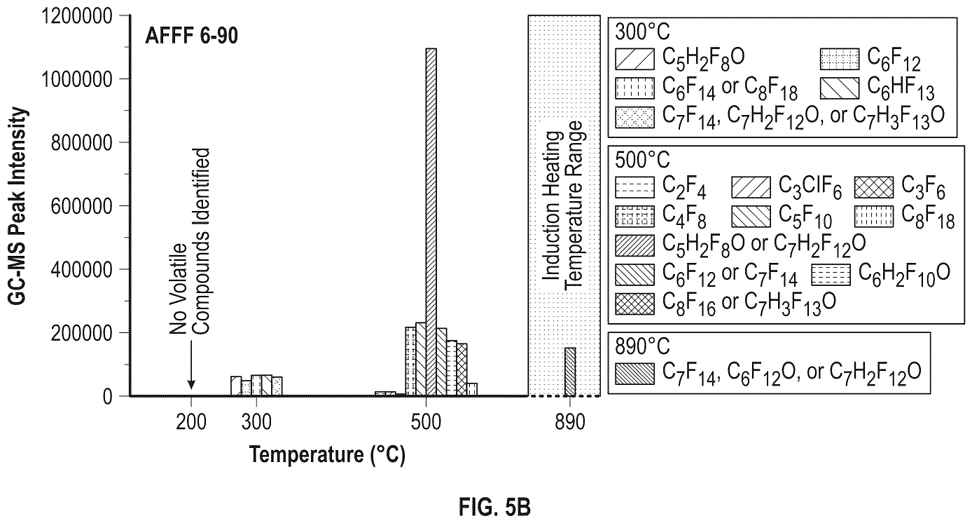

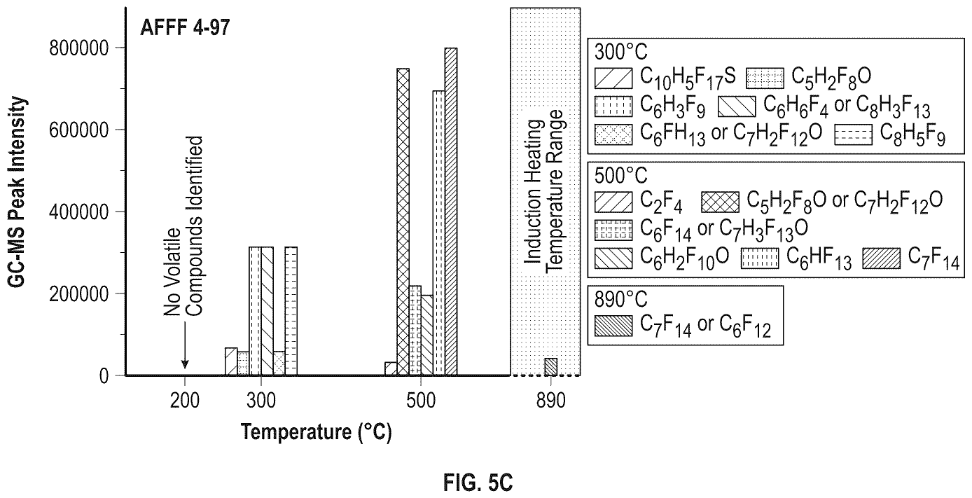

Careful temperature control can help minimize the risk of generating harmful gaseous products, promoting PFAS mineralization. When heated at low and moderate temperatures and in the absence of granular activated carbon, a significant portion of the thermal degradation products of PFAS includes gaseous compounds. One potential advantage of HFH is the ability to rapidly increase the temperature, allowing it to pass quickly through the low to moderate temperature range where many fluorinated PFAS species are likely to be generated. As depicted in FIGS. 5A-5C, AFFFs generated numerous volatile pyrolysis products at temperatures ranging from 300-500° C. When the temperature increased to 890° C., most of these gaseous products vanished, indicating their decomposition at elevated temperatures. The overall product distribution exhibited a bell-shaped curve with respect to temperature. Due to the absence of standards and effective detection methods, the quantities of these products were characterized by their MS peak intensities.

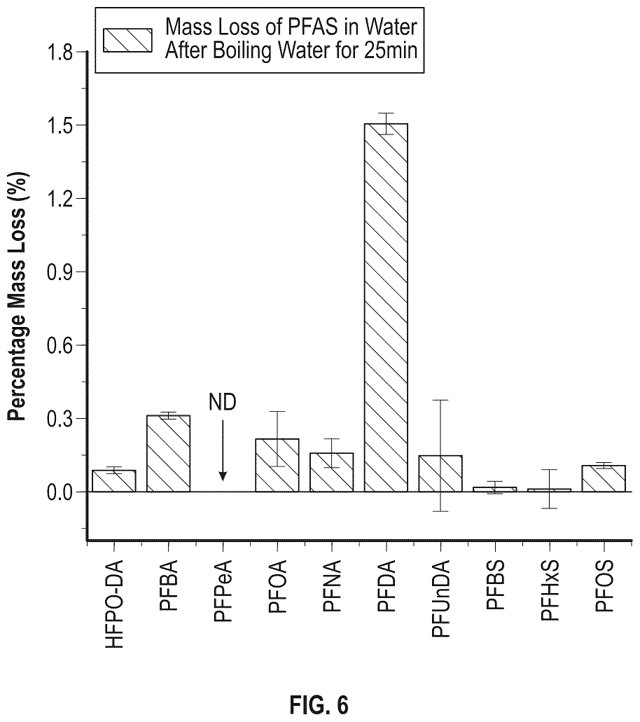

Understanding the behavior of PFAS during thermal soil remediation processes is of significant importance, particularly considering that soils contain varied moisture levels. As surfactants, PFAS could potentially adhere to water vapor or aerosols produced during thermal treatment. However, our recent investigations have indicated minimal PFAS adsorption to water vapor during the boiling process, as shown in FIG. 6. No PFAS were detected in the solution of the receiving flask. Except for PFDA, the loss of the studied PFAS in the evaporation flask solution was less than 0.5 mol % after boiling water for twenty-five minutes (25 min), as shown in FIG. 6. This indicates a minimal rate of PFAS loss during the water boiling process. These findings hold significance as they offer the initial understanding of the potential reduction of PFAS in water vapor.

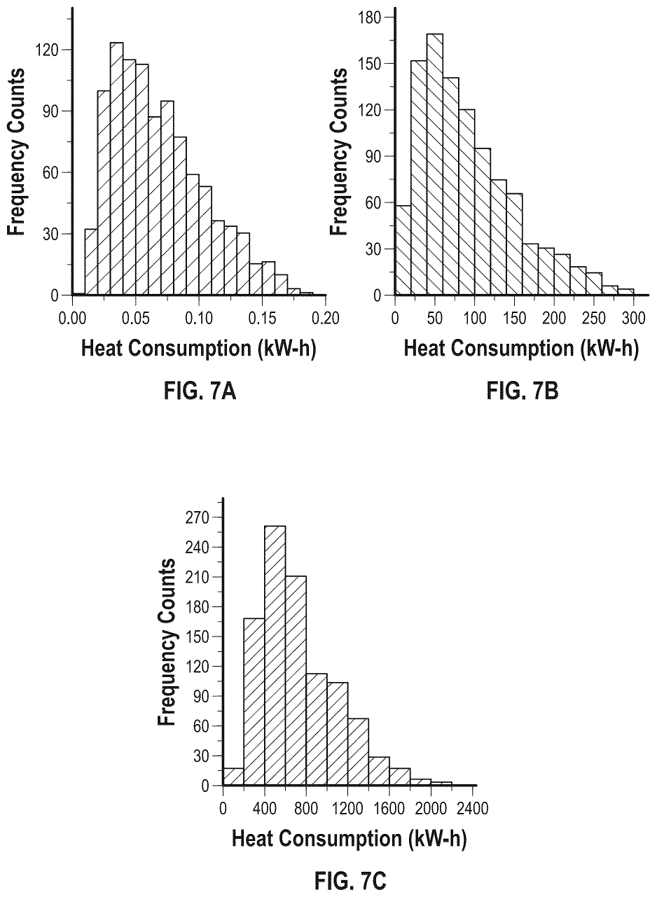

Thermal remediation techniques, such as thermal desorption and smoldering, have shown promise for the treatment of PFAS-contaminated soil. Thermal desorption at low and moderate temperatures is a widely used remediation method that involves heating contaminated soil to evaporate and separate volatile contaminants, which are then collected and treated in an off-gas treatment system. The goal of thermal desorption is not to decompose the contaminants, but rather mobilize them from soil. Smoldering is a thermal technology used for soil remediation, which employs low-temperature, self-sustaining combustion processes to degrade, immobilize, or remove contaminants. Through harnessing the inherent heat of reaction, this technique effectively treats a wide range of organic pollutants. However, their energy efficiency, environmental impact, and overall performance can differ significantly. The energy consumption in the HFH process to thermal desorption and smoldering are compared in FIGS. 7A-7C.

As illustrated in FIG. 7A, HFH is a much more energy-efficient method for the remediation of PFAS-contaminated soils than for thermal desorption and smoldering. The heat consumption by HFH is markedly lower, by several orders of magnitude, than that of thermal desorption and smoldering. These results suggest that HFH has the potential to become a preferred method for energy-efficient remediation of organic-contaminated soils.

Smoldering can be energy-efficient in comparison with thermal desorption, as the heat generated by the combustion process is used to sustain the reaction and treat the soil, as shown in FIG. 7B.

As illustrated in FIG. 7C, while thermal desorption can be effective in treating a range of volatile and semi-volatile organics, its energy efficiency is low; the heat loss to the surroundings can be significant, especially in large-scale or in situ applications, leading to higher energy consumption.

In addition to the low energy consumption, HFH allows for rapid and uniform heating of soil matrices in contrast to conventional thermal methods (e.g., thermal desorption, ovens and furnaces) (Table 2). This not only results in efficient removal and degradation of PFAS in soil (FIGS. 1A-1B, 2A-2B, 3A-3C, and 4A-4F), but also reduces the risk of harmful gaseous products formed at low and moderate temperatures (FIGS. 5A-5C). Additionally, the non-contact nature of induction heating reduces equipment wear, providing enhanced control over the remediation parameters (Table 3).

Although HFH has demonstrated potential as an efficient and effective method for remediating PFAS-contaminated soil, there are several challenges and limitations that need to be addressed for its successful large-scale application (Table 3).

First, the scale-up of HFH technology from laboratory-scale to field-scale applications can be challenging due to the complexity of soil properties, contamination levels, and spatial heterogeneity at larger scales. Effective large-scale application of HFH requires careful consideration of factors such as heat distribution, temperature control, and treatment time to ensure uniform and efficient PFAS degradation across the contaminated area. Additionally, the design of the HFH system, including the choice of coil configuration and power supply, needs to be optimized for field-scale applications to maximize efficiency and minimize energy consumption.

Furthermore, the potential environmental impact of HFH, such as the formation of harmful gaseous products from PFAS, needs to be carefully assessed and managed for large-scale applications. The release of reactive F species (e.g., F radicals and HF) from PFAS can lead to corrosion in the steel reactor, which can be costly to repair and limit its large-scale application. The addition of kaolinite is effective in quenching reactive F species released from PFAS upon heating. Careful temperature control and monitoring, as well as the development of appropriate off-gas treatment systems, can help mitigate these environmental concerns.

Lastly, like several intensive remediation techniques, thermal treatment has its drawbacks. Among these, one notable limitation is its potential to affect soil texture adversely. The short heating duration associated with high-frequency heating might offer a slight reprieve, potentially causing less harm to the soil texture than other prolonged thermal procedures or aggressive chemical and physical treatments.

Understanding the mechanisms of PFAS degradation by HFH is critical for optimizing the remediation process and developing efficient strategies for treating PFAS-contaminated soil. The mechanisms of PFAS degradation by HFH are potentially complex and can involve a combination of thermal degradation and reactive species formation. PFAS can be thermally decomposed through initial, chain propagation, termination, and recombination mechanisms. The extent of thermal degradation is strongly influenced by the temperature, with higher temperatures generally leading to more efficient PFAS degradation. HFH can rapidly generate high temperatures within the soil, which can overcome the thermal stability of PFAS and promote their degradation.

Another potential mechanism of PFAS thermal degradation, which has been overlooked in the literature, is the formation of reactive species, such as radicals or reactive species, which can attack and break the carbon-fluorine bonds in PFAS. High temperatures generated by HFH can promote the formation of reactive species, either through the thermal decomposition of soil components, such as organic matter, or through C—F bond dissociation, releasing reactive F species from PFAS at elevated temperatures. F radicals are highly reactive, and the presence of these reactive species can contribute to the fast PFAS degradation as observed during HFH.

These mechanisms can be influenced by factors such as temperature, soil composition, and PFAS type, highlighting the need for a comprehensive understanding of these factors to optimize the HFH process and develop efficient remediation strategies. There are detailed mechanisms of PFAS degradation by HFH that can identify the optimal conditions for achieving efficient and environmentally friendly remediation of PFAS-contaminated soil.

PFAS contamination in soil poses significant risks to human health and the environment due to their persistence, bioaccumulative nature, and potential toxicity. Existing remediation methods for PFAS-contaminated soil include excavation and disposal in secure landfills, soil washing, and adsorption onto activated carbon or other materials. However, these techniques often have limitations in terms of efficiency, cost, and environmental impact. Therefore, there is a growing need for innovative and sustainable solutions to address PFAS contamination in soil. HFH is a highly energy-efficient thermal remediation method, as HFH generates heat directly within the target material, minimizing heat loss to the surroundings. The use of electromagnetic fields to generate heat within the soil allows for rapid and uniform heating, which can contribute to shorter treatment times and lower overall energy consumption. In addition, the data of this study showed varying degradation rates for PFAS in different classes during HFH. For example, the degradation of PFAS varies in the following order: PFECAs>PFCAs>PFSAs. This observation may be attributed to the differences in thermal stability and the energy required to break the O—F, C—F, and S—F bonds in PFECAs, PFCAs, and PFSAs. HFH can be tailored to target specific PFAS class by adjusting the treatment time, as shown in FIGS. 1A-1B, potentially reducing the energy requirements of the process. These features make HFH a viable alternative for PFAS-contaminated soil remediation and are expected to attract increasing attention from researchers and practitioners in the field. Furthermore, this study pioneers in providing the first exploration into the potential reduction of PFAS in water vapor, marking its critical importance in this field of research.

When comparing HFH with other thermal remediation methods, such as thermal desorption and smoldering, in terms of energy efficiency, HFH appears to offer several advantages. HFH generates heat directly within the target material, rapidly achieves high temperatures, and selectively target specific PFAS contributes to its energy-efficient nature. While each thermal remediation method has merits and limitations, HFH may present a more energy-efficient and environmentally friendly alternative for the remediation of PFAS-contaminated soil.

HFH is also particularly beneficial because HFH can be further optimized and scaled-up for the successful treatment of PFAS contamination. HFH is a sustainable and cost-effective remediation solution. The development and application of HFH for PFAS remediation have significant implications for the field. As an energy-efficient and potentially more cost-effective method, HFH can address some of the limitations of existing remediation technologies. The ability to rapidly generate high temperatures and target specific contaminants offers the possibility of more efficient and environmentally friendly PFAS degradation. The field of HFH for PFAS remediation can be advanced so that the field contribute to the development of more sustainable and effective solutions for managing PFAS-contaminated sites globally. The field of HFH for PFAS remediation can advance to significantly contribute to the development of more sustainable and effective solutions for managing PFAS-contaminated sites globally.

PFAS contamination in soil is a major environmental concern due to its persistent, bioaccumulative nature, and potential toxicity. The present disclosure introduces HFH, an innovative thermal remediation method, as a more sustainable and energy-efficient solution. With the ability to rapidly degrade PFAS in soil irrespective of their concentrations, HFH emerges as a potentially cost-effective alternative to current remediation methods. The widespread adoption of HFH can significantly alleviate the environmental and health risks associated with PFAS contamination. Ongoing research into optimizing HFH could revolutionize this approach to managing PFAS-contaminated sites, promoting more effective and sustainable soil remediation strategies.

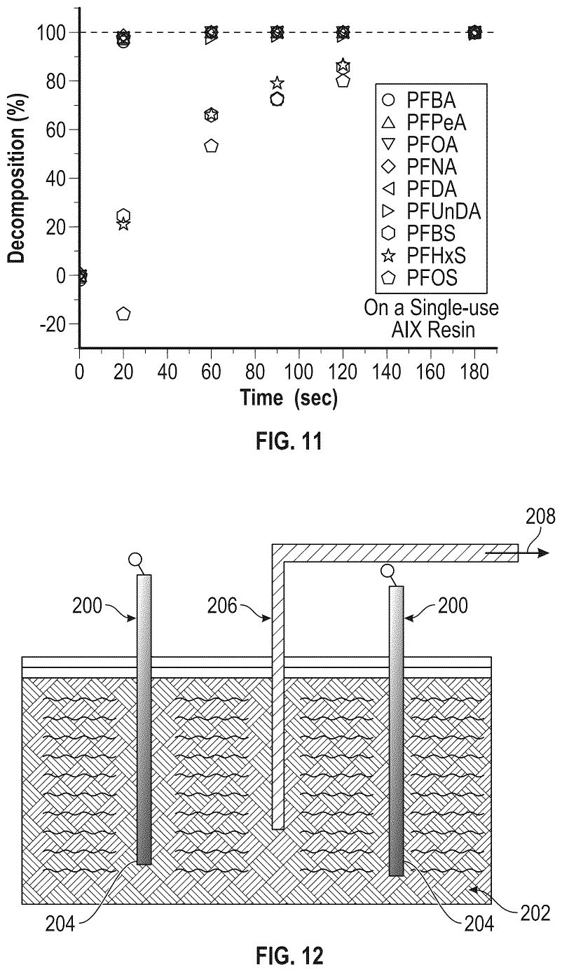

A novel magnetic-driven portable high-frequency magnetothermal technique (M-MAT) has been developed and is a safe and energy-effective alternative to existing remediation approaches such as thermal desorption, smoldering, supercritical water oxidation (SCWO), and hydrothermal alkaline treatment (HALT). This cutting-edge M-MAT method is designed to rapidly decompose per- and polyfluoroalkyl substances (PFAS) in a matter of seconds (see FIGS. 1A-1B, 2A-2B, 3A-3C, 4A-4F, 5A-5C, 6, 7A-7C, 8, 9, 10A-10B, 11, and 12). The M-MAT method specifically targets mineralizing products of incomplete destruction (PIDs) of PFAS, leveraging the unique advantages of magnetic-driven technology for enhanced efficiency and effectiveness. Innovative treatments for the effective decomposition of PFAS and PIDs can be derived therefrom.

The present disclosure almost undoubtedly describes the first magnetic-driven PFAS destruction technology that offers seamless integration with existing remediation methods for destroying PIDs. This allows critical parameters to be carefully assessed and sequentially address the following key objectives, including: applying M-MAT for complete destruction of PFAS in biosolids, spent granular activated carbon (GAC), and spent anion exchange (AIX) resins; evaluating and optimizing the performance of M-MAT for complete destruction of PFAS in aqueous film-forming foams (AFFFs); developing and optimizing a semi-pilot-scale M-MAT device using field-impacted soils containing PFAS mixtures and common soil remediation complications; evaluate the performance of a M-MAT prototype system in an on-location pilot test at a site; and evaluating the performance of M-MAT for removal and decomposition of co-contaminants, hydrocarbon surfactants (HS) in particular, that are frequently found in AFFFs.

M-MAT can be applied to treat harmful chemicals such as PFAS and co-contaminants. These chemicals can be found in liquid samples, such as multiple 3M AFFF samples, or solid samples, such as (i) field-impacted soils, such as those near a fluoropolymer manufacturing facility, (ii) commercial (e.g., Grade A) biosolids samples, and (iii) spent media from water treatment facilities. The key issues that the M-MAT technique can address include: (i) underlying PFAS degradation mechanisms during high-frequency magnetothermal treatments, (ii) effects of texture and properties of solid samples, and (iii) effects of degradation of co-contaminants.

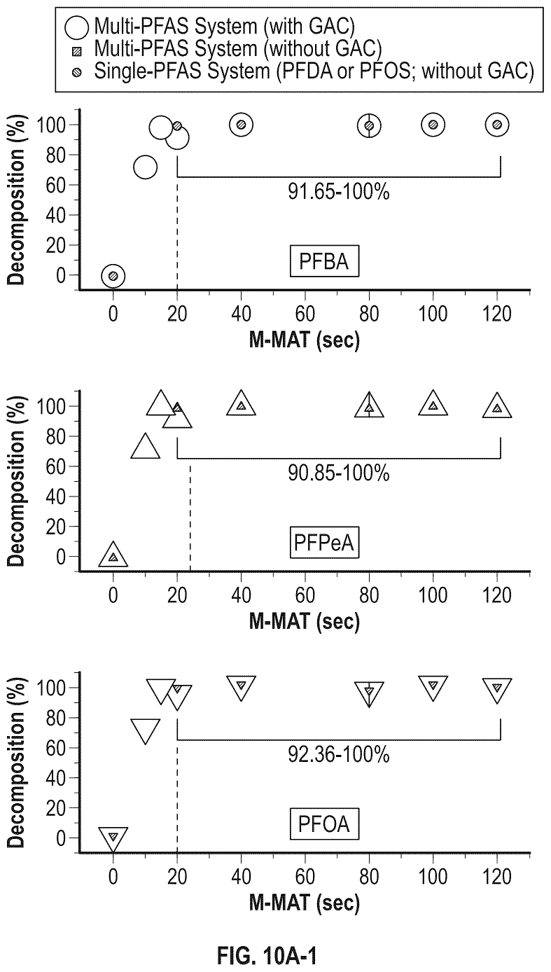

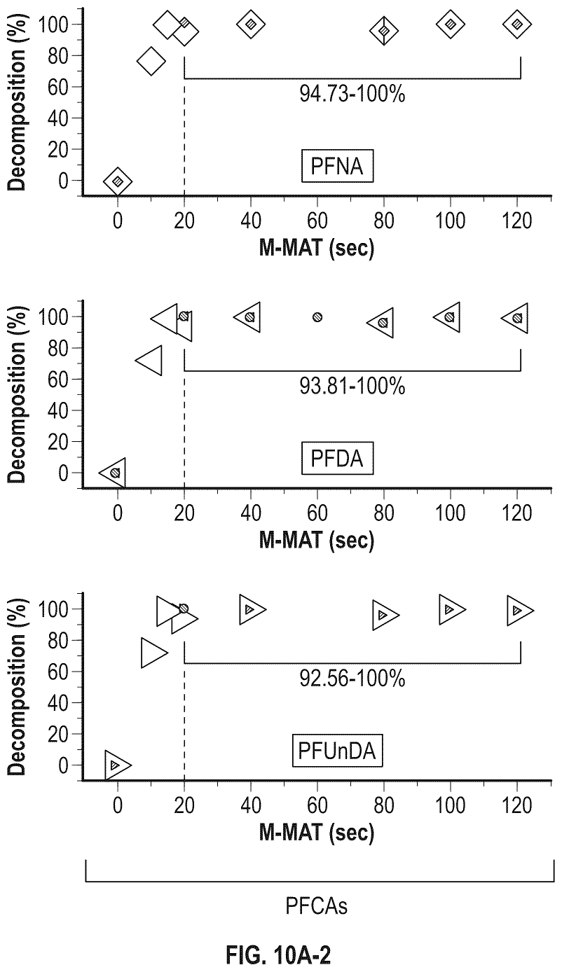

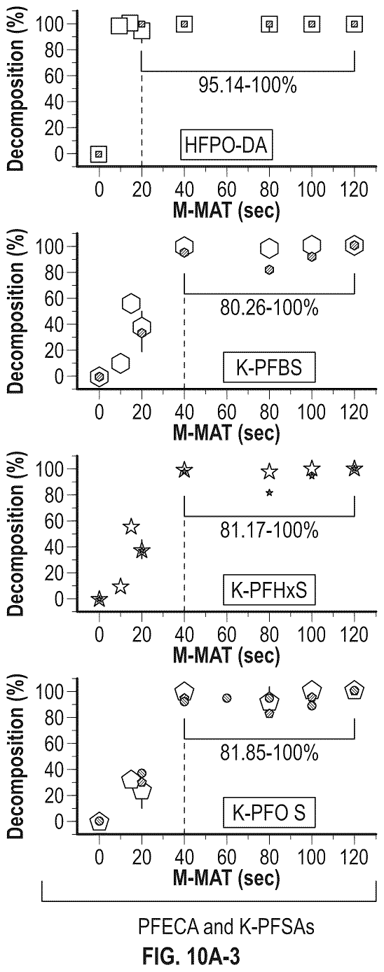

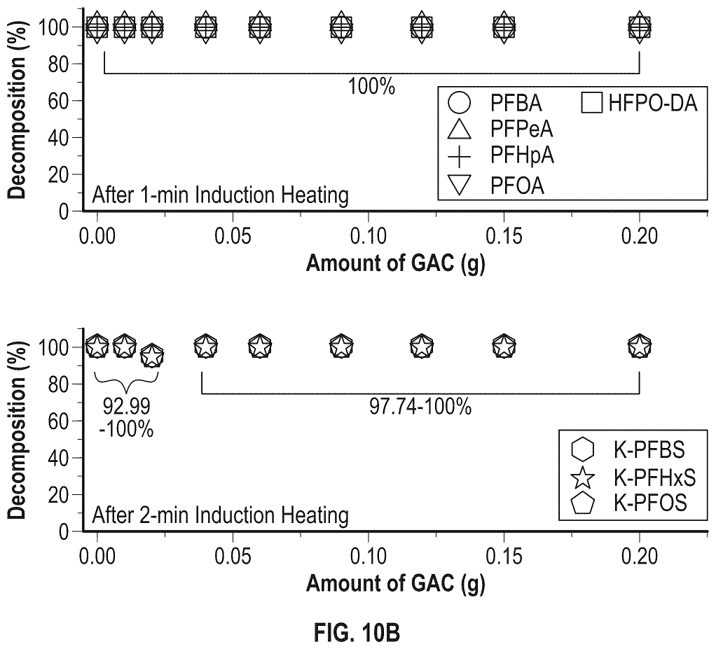

M-MAT can be optimized for the treatment of PFAS-laden solid samples based on the following results: M-MAT rapidly and completely degraded PFAS in spent GAC, AIX resins, and soil samples in thirty to one hundred twenty seconds (FIGS. 10A-B and 11). Contrary to current thermal remediation methods, M-MAT does not necessitate continuous operation and proves effective in significantly short treatment durations measured in seconds. The M-MAT technology offers several additional advantages compared to SCWO and HALT because it has proven highly effective in treating recalcitrant PFAS (e.g., PFOS; FIGS. 10A-B and 11, and FIGS. 3A-3B) and short-chain PFAS (FIGS. 10A-B and 11, and FIGS. 3A-3B) and stands out with the portability and low unit capital and operating costs (Table 4).

TABLE 4
Comparison of current thermal approaches and M-MAT for PFAS destruction.

| | Existing Methods | M-MAT |
|---|---|---|
| Residence time | Minutes to hours | Seconds |
| Reactors and | Furnace or oven | Metallic reactor |
| heating method | Heat is transferred through | Heat is generated within the |
| | conduction, convection, and | metallic reactor by electromagnetic |
| | radiation | induction |
| Advantages | Relatively mature technologies | High heating efficiency (80-90%) |
| | with laboratory-, pilot-, and even | High energy conversion efficiency |
| | full-scale data | M-MAT reactors are easy to install |
| | | and maintain |
| | | Highly effective for PFSAs and |
| | | short-chain PFAS |

Key parameters include frequency, power level, and treatment duration. M-MAT can be tailored for field-impacted soil samples collected from known PFAS-contamination sites. The performance of M-MAT for effectively degrading PFAS, such as those measured by the USEPA Method 1633, and co-contaminants present in AFFFs can be evaluated.

A complete fluorine (F) mass balance can be established.

PFAS decomposition products can be identified using high-performance liquid chromatography (HPLC) coupled with triple quadrupole mass spectrometer (MS/MS) based on the EPA Method 1633; gaseous products can be collected and analyzed by gas chromatography coupled with ion trap MS (GC-Q-trap MSn); an open library with all PFAS decomposition products can be developed and shared to the scientific community; and quantitative-structure-activity-relationships (QSARs) can be established to understand the effect of PFAS structure and predict the M-MAT mineralization efficiency of other PFAS. The results shown in FIGS. 10A-B, 11, and 12 demonstrate the effectiveness of these strategies.

This project aims to advance PFAS remediation via M-MAT, offering a novel, efficient, and safe solution compared to existing methods like incineration and pyrolysis. The worker risk/safety profile for M-MAT is appealing to the private sector compared to other technology options. M-MAT and the related data complements the extensive research experience demonstrated above with respect to PFAS, water and soil chemistry, remediation, and knowledge of technological demands for treating PFAS-contaminated substances. The novel remediation/treatment approach (M-MAT) developed in herein helps to (i) improve the management of PFAS sites by facilitating the establishment of energy-effective (Table 4 and FIGS. 7A-7C), cost-effective, efficient remedial methods for complete destruction of PFAS and PIDs, (ii) provide another option the government and other agencies (e.g., airports) to reliably address PFAS-contaminated soils and wastes, (iii) create new knowledge on decomposition mechanisms of various PFAS in high-frequency magnetothermal treatments, (iv) identify the effect of matrices (e.g., soil properties and co-contaminants), and (iv) enhance the destruction of PIDs, especially gas-phase compounds, and expedite the cleanup and closure of impacted sites.

M-MAT's effectiveness is demonstrated in degrading PFAS in various matrices, optimizing its operation parameters. M-MAT provides critical data and insights and meaningfully contributes toward the urgent need for effective PFAS treatment technologies. Many constituencies would benefit directly or indirectly from M-MAT, including government agencies, airports, and commercial sector companies with PFAS-related liabilities, soil remediation professionals, the GAC industry, EPA and other regulators, communities who are concerned with the presence of PFAS in soils and biosolids, the broader research and education communities, and other stakeholders.

PFAS-containing solid samples. PFAS are synthetic organofluorine chemicals that have been mass-produced since the 1950s for various products, such as nonstick cookware and AFFFs for firefighting devices. As is often the case with industrial chemicals, PFAS do not remain solely in their intended environments. They have been detected in surface soils in numerous places around the world since the beginning of this millennium. PFAS manufacturing facilities, landfills, and AFFF-impacted sites constitute predominant sources of soil contamination. A number of sites in the United States have been identified where there are known or suspected releases of PFAS due to the use of AFFFs for fire training. In rural areas without major point sources, land application of PFAS-containing biosolids, reclaimed wastewater, and pesticides are potential contamination sources. PFAS in soil can pose a threat to human health through ingestion and inhalation of fugitive soil particles and an indirect route, including the PFAS transfer from soil to crops and to drinking-water sources.

Unlike drinking water treatment practices, solid samples (soils, biosolids, spent media) containing PFAS are challenging to cleanup as limited technologies can be applied to solid samples. Furthermore, PFAS remediation activities are complicated, involving not only environmental factors but also a variety of practical management problems, including economic issues affecting the implementation of lasting solutions. A few remediation approaches have been investigated, including soil flushing, on-site sequestration, ball milling, and thermal desorption and decomposition treatments. The remediation efficiency, however, may be strongly influenced by the concentration of PFAS in soil that can range up to >10,000 ng/gsoil in “hot spots” of PFAS contamination.

Current remediation methods include thermal-based approaches that have emerged as an attractive means to decontaminate PFAS-laden GAC, resins, and other solid materials (e.g., soil, biosolids, and biomass). The degradation of PFAS in soil and spent GAC using various conventional thermal treatment approaches has been researched (e.g., dry thermal air oxidation, pyrolysis, GAC thermal regeneration, and GAC thermal reactivation). The decontamination of PFAS-containing soils by thermal desorption has also been examined. The thermal remediation of PFAS-contaminated soil by smoldering combustion at ~1000° C. has also been investigated. In these previous studies, a significant heating time (up to 14 days) or a very high heating temperature (e.g., >1000° C.) was employed. The costs of thermal treatment rise significantly with the temperature and residence time. To be effective, researchers are encouraged to develop energy-effective methods or improve the energy consumption rate of their current remediation efforts. Others have systematically investigated HALT treatments of PFAS, and SCWO has also been extensively examined for degrading PFAS.

These thermal treatment approaches, including those used in PI Xiao's previous studies, are energy-intensive since they involve heating the media (such as liquid in SCWO and HALT) before transferring heat to the PFAS (Table 4); they require continuous operation; and existing technologies, such as SCWO, HALT, plasma, and hydrated electron-based reduction methods, are inefficient to fully decompose recalcitrant PFSAs (e.g., PFOS) and short-chain PFAS.

To overcome these shortcomings, the innovative treatment method shown in FIG. 8 can also utilize M-MAT. The M-MAT strategy fulfills the four criteria outlined in Table 4: (a) M-MAT enables ultra-fast mineralization of recalcitrant PFSAs (e.g., PFOS) and short-chain PFAS (FIGS. 10A-B, 11, and 12), (b) demonstrates non-selectivity by effectively addressing PFAS of various classes and co-occurring contaminants, (c) incurs low energy costs (FIGS. 7A-7C), and (d) can be implemented in a fully portable low-cost unit.

The M-MAT concept operates fundamentally on the Joule heating effect, wherein the heat is generated within a metallic reactor through electromagnetic induction, eliminating the need for direct contact between the induction heater and the reactor. Additional heat is produced by hysteresis losses for magnetic materials during thermal treatment. The energy consumption of M-MAT is considerably lower than that of existing thermal remediation methods by several orders of magnitude based on Monte Carlo calculations (FIGS. 7A-7C). The M-MAT system is portable, allowing easy transportation and application in various field settings. This portability expands its usability across different contaminated sites, irrespective of their location.

The performance of M-MAT in several conditions is shown throughout FIGS. 10A-B, 11, and 12. (I) Complete degradation of PFCAs (60 sec), PFECAs (60 sec), and PFSAs (120 sec) in spent GAC, AIX resins, and soil were achieved with M-MAT. (II) Adding NaOH into the M-MAT treatment process led to substantial mineralization of PFOA and PFNA and the generation of NaF, an environmentally benign substance. (III) Polyfluoroalkyl precursors in AFFFs were found to degrade completely within 60 sec of M-MAT; no residual cationic, zwitterionic, anionic, or non-ionic intermediate products were detected following the treatment. (IV) Data on the degradation of PIDs using M-MAT were also collected. 99% degradation and 70-82% mineralization of both PIDs (based on perfluoroheptane-1 and perfluorooctene-1, primary PIDs of PFOA and PFOS) were demonstrated in forty seconds (40 s) and on hundred twenty seconds (120 s), respectively. Further improvement in the M-MAT operation conditions will lead to a complete mineralization of PIDs.

The degradation of PFAS in conventional thermal processes occurs in the following stages (rxns. 1-3): (1) melting, (2) evaporation of melted molecules, and (3) degradation of gas-phase PFAS molecules:

From the foregoing, it can be seen that the present disclosure accomplishes at least all of the stated objectives.

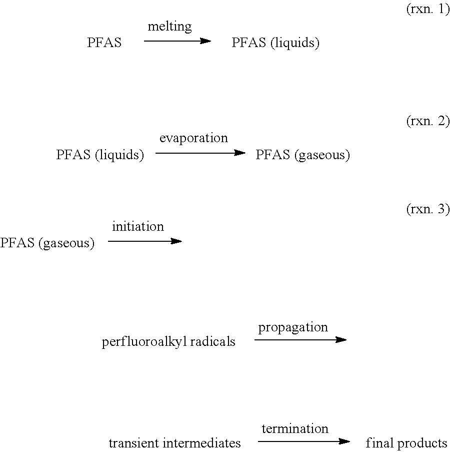

The rate-limiting step in PFAS degradation is the thermal phase transitions, specifically melting and evaporation. Consequently, using M-MAT to rapidly bypass these phase transitions can accelerate the thermal degradation of PFAS. The data supports this, namely: the Arrhenius activation energy (E_{A,rxn.2}) to be 105-113 KJ/mol corresponding to the evaporation (rxn. 2) of melted PFOA molecules at 116-149° C. The E_{A,rxn.3} was determined to be 77 kJ/mol in air or 87-89 KJ/mol in N2 at 200-400° C. A comparison of E_{A,rxn.2} and E_{A,rxn.3} suggests that the evaporation of melted PFOA molecules (rxn. 2) is a rate-limiting step. To further this, the values of E_{A,rxn.2} (287-360 KJ/mol) and E_{A,rxn.3} (121.4 KJ/mol) were determined for K-PFOS. The results again demonstrate the evaporation of melted PFOS molecules as a rate-limiting step, consistent with the rate-limiting step in PFAS degradation being the thermal phase transitions. These results evidence that thermal degradation of solid-state and melted/liquid-state PFAS is possible with M-MAT, which largely reduces the energy and time needed for thermal phase transitions.

The energy requirements of M-MAT compared to current remediation technologies, such as smoldering and thermal desorption were also evaluated. As illustrated in FIGS. 7A-7C, M-MAT requires significantly less energy than these existing methods, establishing it as an energy-efficient and sustainable approach to remediation.

Based on the available results on M-MAT, a semi-pilot-scale M-MAT device 200 has been developed to treat field-impacted soils 202. A microcosm container (~0.6 m³) was made in the previous PFAS fate and transport project, as shown in FIG. 12. The container will be thoroughly cleaned with acetonitrile, packed with AFFF-impacted soil, and sealed. The cover will be drilled with four holes over different locations. Three of the holes will be used to insert the M-MAT tubing 206, and the four holes will be connected to a low-pressure vacuum pump to collect the volatile gaseous products 208 by an Amberlite® XAD-2 resin column and then a series of beakers containing hexane, methanol, and distilled water. The resins will be extracted with another hexane solution. Then, the hexane solutions will be combined, concentrated to near dryness under a gentle stream of nitrogen, and redissolved in 100 μl of hexane before the analysis by a GC-MS/MS system at the University of Missouri. The nonpolar gaseous products will be quantified if analytical standards are available. Compounds without an authentic standard will be semiquantified based on the response factor of standards most closely matched in structure and retention characteristics. Concentrations of residual PFAS, if any, in methanol and distilled water will be analyzed by HPLC-MS/MS.

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “near-complete” refers to an amount greater than 99.9% unless its immediate context expressly indicates otherwise.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

When an element is referred to as being “connected,” “coupled,” “mated,” “attached,” “fixed,” etc. to another element, the element can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, terms such as (i) “communicatively connected” or (ii) “fluidly connected” include (i) all variations of information exchange and routing between two electronic devices, including intermediary devices, networks, etc., connected wirelessly or not and (ii) all variations of fluid exchange and routing between two fluidic bodies, including intermediary fluid paths, flows, etc., connected indirectly or not.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A method for remediating soil comprising:
applying an induction heating tool to apply high-frequency heating (HFH) to a combination of carbon-based matter and per- and polyfluoroalkyl substances (PFAS).

2. The method of claim 1, further comprising treating soil containing the PFAS and the carbon-based matter.

3. The method of claim 1, further comprising achieving rapid degradation with said high-frequency heating without having to transport the soil to a centralized waste treatment facility.

4. The method of claim 1, further comprising employing an electromagnetic field to heat the combination without directly contacting a heat source, wherein the heat source is an alternating current in a coil that creates an oscillating magnetic field, inducing eddy currents in a conductive material therewithin.

5. The method of claim 1, wherein the organic matter comprises spent carbon.

6. The method of claim 1, further comprising, in less than one hundred and twenty seconds (120 s), increasing the temperature to a temperature above where fluorinated PFAS are formed.

7. The method of claim 1, wherein the PFAS comprise perfluoroalkylcarboxylic acids (PFCAs).

8. The method of claim 7, wherein the PFCAs are selected from the group consisting of: perfluorobutyric acid (PFBA), perfluoropentanoic acid (PFPeA), perfluorooctanoic acid (PFOA), perfluorononanoic acid (PFNA), perfluorodecanoic acid (PFDA), perfluoroundanoic acid (PFUnDA), and perfluorooctanoic acid (PFOA).

9. The method of claim 7, further comprising targeting at least one C—F bond in the PFCAs.

10. The method of claim 1, wherein the PFAS comprise perfluorosulfonic acids (PFSAs).

11. The method of claim 10, wherein the PFSAs are selected from the group consisting of: perfluorobutane sulfonic acid (PFBS), perfluorohexane sulfonic acid (PFHxS) and perfluorooctane sulfonic acid (PFOS).

12. The method of claim 10, further comprising targeting at least one S—F bond in the PFSAs.

13. The method of claim 1, wherein the PFAS comprise perfluoroalkyl ether carboxylic acids (PFECAs).

14. The method of claim 13, wherein the PFECAs are selected from the group consisting of: perfluoro-2-methyl-3-oxahexanoic acid (HFPO-DA), perfluoro-2,5-dimethyl-3,6-dioxanonanoic acid (HFPO-TA), and perfluoro-2,5,8-trimethyl-3,6,9-trioxadecanoic acid (HFPO-TeA).

15. The method of claim 13, further comprising targeting at least one O—F bond in the PFECAs.

16. A portable high-frequency heating (HFH) device for synthetically producing geothermal energy comprising:
a coil capable of creating an alternating current in an oscillating magnetic field;
a conductive material through which eddy currents are induced by the coil to generate heat in soil; and
a mount for securing the portable HFH device in a stable position with respect to the ground while the heat is generated.

17. The portable HFH device of claim 16, further comprising a reaction chamber through which the soil is moved through as the soil is heated.

18. The portable HFH device of claim 16, further comprising an infrared thermometer for monitoring a temperature of the soil.

19. A magnetic-driven portable high-frequency magnetothermal (M-MAT) method comprising:
rapidly decomposing per- and polyfluoroalkyl substances (PFAS) in less than one hundred twenty (120) seconds;
specifically targeting mineralizing products of incomplete destruction (PIDs) of PFAS; and
applying a magnetic-driven portable high-frequency magnetothermal (M-MAT) technique to destroy (i) PFAS in biosolids, (ii) spent granular activated carbon (GAC), and/or (iii) spent anion exchange (AIX) resins.

20. The method of claim 19, further comprising removing and decomposing hydrocarbon surfactants (HS) that are in aqueous film-forming foams (AFFFs).
